(19) United States
(12) Patent Application Publication
(10) Pub. No.: US 2026/0192470 A1
(43) Pub. Date: Jul. 9, 2026

(54) Robotic Tool Changer Having An Integrated Force/Torque Sensor

(71) Applicant: ATI Industrial Automation, Inc., Apex, NC (US)

(72) Inventors: Ian Stern, Raleigh, NC (US); Joseph Lipsey, Lillington, NC (US)

(21) Appl. No.: 19/012,196

(22) Filed: Jan. 7, 2025

(51) Int. Cl. B25J 15/04; B25J 13/08; B25J 19/02

(52) U.S. Cl. CPC B25J 15/0416; B25J 13/085; B25J 19/02

(57) ABSTRACT

A robotic tool changer includes a master-side assembly that couples to a robotic arm, and a tool-side assembly that couples to, and is interposed between, the master-side assembly and a tool used by a robot. Additionally, a locking mechanism and a force/torque sensor are integrated into one of the master-side and tool-side assemblies. The locking mechanism moves between a locked position and an unlocked position to lock and unlock the master-side assembly to and from the tool-side assembly. The force/torque sensor includes sensing structures that elastically deform responsive to an applied force and transducers affixed to the sensing structures. The transducers send electrical signals representing a magnitude and a direction of a detected applied force to a measurement circuit. The force/torque sensor, a part of the locking mechanism, and the master-side or tool-side assembly into which they are integrated may form unitary member.

### FIELD OF INVENTION

The present disclosure relates generally to tool changers for robotic applications, and in particular to a robotic tool changer having integrated sensors configured to detect changes in force and torque applied to the tool changer.

### BACKGROUND

Industrial robots have become an indispensable part of modern manufacturing. Whether transferring semiconductor wafers from one process chamber to another in a cleanroom or cutting and welding steel on the floor of an automobile manufacturing plant, robots perform many manufacturing tasks tirelessly, in hostile environments, and with high precision and repeatability. In many cases, a robot arm or a tool attached thereto may contact a workpiece. In such cases, the force and/or torque applied as a result of that contact must be closely monitored. Accordingly, force/torque sensors are an important part of many robotic systems.

The Background section of this document is provided to place embodiments of the present disclosure in technological and operational context, to assist those of skill in the art in understanding their scope and utility. Approaches described in the Background section could be pursued but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

According to one or more embodiments described and claimed herein, a robotic tool changer having a master-side assembly and a tool-side assembly comprises an integrated force/torque (F/T) sensor and locking mechanism. In one embodiment, the locking mechanism and the F/T sensor are integrated with the master-side assembly, while in another embodiment, the locking mechanism and the F/T sensor are integrated with the tool-side assembly. The locking mechanism moves between a locked position and an unlocked position to respectively couple and uncouple the master-side and tool-side assemblies, while the F/T sensor detects applied forces and sends electrical signals representing the magnitude and direction of those forces to a measurement circuit. Regardless of the embodiment, however, the robotic tool changer of the present disclosure may be robotically actuated, tool-stand actuated, manually actuated, magnetically actuated, pneumatically actuated, or electrically actuated.

In some embodiments, the integrated F/T sensor comprises a component that is independent of, and separate from, both the master-side and tool-side assemblies. In such cases, the F/T sensor is coupled to either the master-side assembly or the tool-side assembly. When integrated with the master-side assembly, the F/T sensor is positioned between the master-side assembly and the robotic arm and mates directly to both the master-side assembly and the robotic arm. When integrated with the tool-side assembly, however, the integrated F/T sensor is positioned between the tool-side assembly and a tool used by a robot and mates directly to both the tool-side assembly and the tool. In other embodiments, the integrated F/T sensor and the master-side or tool-side assembly into which it is integrated are manufactured from a single piece of metal or metal alloy such that they form a unitary member.

Additionally, the F/T sensor comprises a plurality of elastically deformable sensing structures specifically configured to elastically deform when a force is applied to the robotic tool changer. Each sensing structure, or “beam,” further comprises pairs of transducers affixed to its surface on either side of a neutral axis bisecting the sensing structure. In operation, each transducer detects the deformation of the sensing structure to which it is affixed due to the applied force. So detected, each transducer sends corresponding electrical signals representing the magnitude and direction of the applied force it detected to a measurement circuit. The present embodiments may use any number and/or type of different F/T sensors configured to operate according to various technologies. However, in one or more embodiments, the integrated F/T sensor may be one or more of a strain gauge, a capacitance sensor, a Surface Acoustic Wave (SAW) sensor, a Fiber Bragg Grating (FBG) sensor, an optical sensor, or any combination thereof.

Accordingly, in one embodiment, the present disclosure relates to a robotic tool changer comprising a master-side assembly that couples to a robotic arm and a tool-side assembly. The tool-side assembly has a first side coupled to the master-side assembly and an opposing second side coupled to the one or more tools used by a robot. Further, both a locking mechanism and a force/torque sensor are integrated into one of the master-side assembly and the tool-side assembly. The locking mechanism is configured to move between a locked position and an unlocked position to respectively couple and uncouple the master-side and tool-side assemblies. The force/torque sensor comprises one or more sensing structures configured to elastically deform responsive to an applied force, and one or more transducers affixed to the one or more sensing structures. Each transducer sends electrical signals representing a magnitude and a direction of the applied force to a measurement circuit.

In another embodiment, the present disclosure provides a master-side assembly for a robotic tool changer. As stated above, the master-side assembly couples to both the robotic arm and a tool-side assembly, and further, integrates both a locking mechanism and an F/T sensor. The locking mechanism moves between a locked position and an unlocked position to respectively couple and uncouple the master-side assembly to and from a tool-side assembly of the robotic tool changer. The F/T sensor comprises one or more sensing structures configured to elastically deform responsive to an applied force, and one or more transducers affixed to the one or more sensing structures. Each of the one or more transducers is configured to send electrical signals representing a magnitude and a direction of the detected applied force to a measurement circuit.

Another embodiment of the present disclosure relates to a tool-side assembly for a robotic tool changer. The tool-side assembly of this embodiment is configured to couple to a master-side assembly of the robotic tool changer and to one or more tools used by a robot. The tool-side assembly also includes an integrated locking mechanism and F/T sensor. The locking mechanism is configured to move between a locked position and an unlocked position to respectively couple and uncouple the tool-side assembly to a master-side assembly of the robotic tool changer. The F/T sensor comprises one or more sensing structures that elastically deform responsive to an applied force and one or more transducers affixed to the one or more sensing structures. Each transducer is configured to send electrical signals representing a magnitude and a direction of the applied force it detects to a measurement circuit.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 is a plan view illustrating a robotic tool changer having an integrated force/torque (F/T) sensor according to embodiments of the present disclosure.

FIG. 2 is a perspective view illustrating a robotic tool changer having an integrated F/T sensor configured according to embodiments of the present disclosure.

FIG. 3 is a perspective view illustrating a robotic tool changer having an integrated F/T sensor configured according to embodiments of the present disclosure.

FIGS. 4A-4B are a perspective view and a plan view, respectively, of a master-side assembly of a F/T sensor configured according to embodiments of the present disclosure.

FIGS. 5A-5B are a perspective view and a plan view, respectively, of a tool-side assembly of a F/T sensor configured according to embodiments of the present disclosure.

FIGS. 6A-6B are perspective views showing the annular collar of a master-side assembly and a bearing race of a tool assembly, respectively, configured according to embodiments of the present disclosure.

FIG. 6C is a perspective view showing the annular collar and the bearing race and further showing the rolling members contained in bores formed in the annular collar contacting sloped surfaces of the cutouts in the bearing race according to embodiments of the present disclosure.

FIG. 7 is a schematic illustration of a locking mechanism showing a series of rolling members contacting opposed sloped surfaces of various cutouts in the bearing race according to embodiments of the present disclosure.

FIG. 8A is a plan view of a force/torque sensor according to embodiments of the present disclosure.

FIG. 8B is an enlarged view of a sensing structure of a F/T sensor illustrated in FIG. 8A.

FIG. 9A is a perspective view illustrating a pair of strain gauges wire bonded to a Printed Circuit Board (PCB) according to embodiments of the present disclosure.

FIG. 9B is a perspective view of a pair of strain gauges surface-mounted to a flexible circuit substrate according to embodiments of the present disclosure.

FIG. 10A is a section view and functional circuit schematic of a quarter bridge circuit topology of strain gauges on a sensing structure according to embodiments of the present disclosure.

FIG. 10B is a section view and functional circuit schematic of an X connection half bridge circuit topology of strain gauges on a sensing structure according to embodiments of the present disclosure.

FIG. 10C is a section view and functional circuit schematic of a half bridge circuit topology having an inverted excitation polarity according to embodiments of the present disclosure.

FIG. 11A is a plan view of a F/T sensor with multiple pairs of strain gauges affixed to a top surface of each sensing structure according to embodiments of the present disclosure.

FIG. 11B is an enlarged view of one sensing structure of the F/T sensor of FIG. 11A, with an overlaid functional circuit schematic depicting a half bridge topology according to embodiments of the present disclosure.

FIG. 12 is a plan view of a F/T sensor having serpentine deformable sensing structures according to embodiments of the present disclosure.

FIG. 13 is a plan view of a F/T sensor having serpentine deformable sensing structures according to other embodiments of the present disclosure.

FIG. 14 is a perspective view of a serpentine deformable sensing structure of the F/T sensor of FIG. 13.

FIG. 15 is a plan view of a F/T sensor having serpentine deformable sensing structures according to another embodiment of the present disclosure.

FIG. 16 is a plan view of a F/T sensor having spiral deformable sensing structures according to embodiments of the present disclosure.

FIG. 17 is a perspective view of a F/T sensor having vertically oriented deformable sensing structures according to embodiments of the present disclosure.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

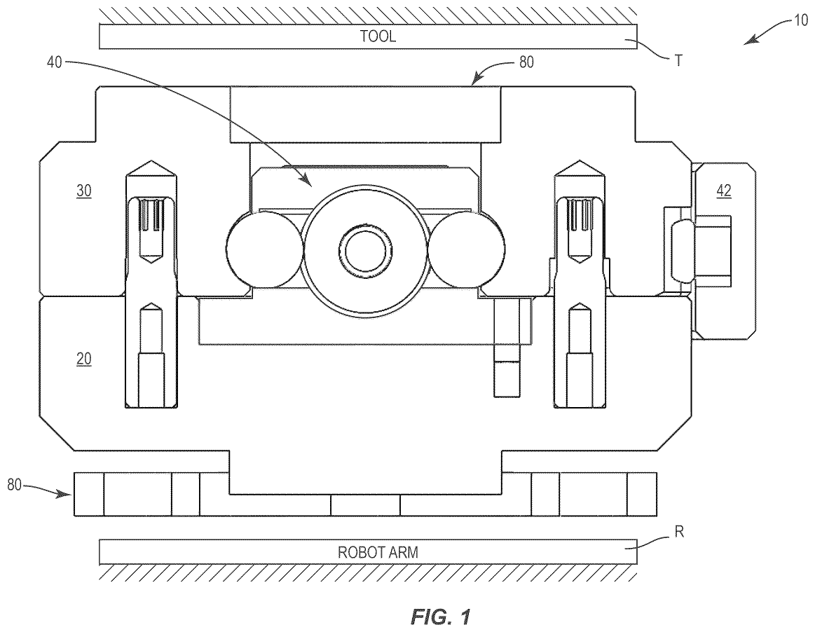

Turning now to the drawings, FIG. 1 illustrates an embodiment of a robotic tool changer 10 having both an integrated force/torque (F/T) sensor and an integrated locking mechanism according to embodiments of the present disclosure. As seen in FIG. 1, this embodiment of the robotic tool changer 10 comprises, inter alia, a master-side assembly 20, a tool-side assembly 30, an integrated locking mechanism 40, and an integrated F/T sensor 80.

The master-side assembly 20 is configured to couple to/mate with a robot arm R, while the tool-side assembly 30 is configured to couple to/mate with one or more tools T that the robot may utilize. Additionally, the master-side and tool-side assemblies 20, 30 are configured to be aligned and releasably coupled directly to each other. To align the master-side assembly 20 at the end of the robot arm R to the tool-side assembly 30 attached to a desired tool T (typically resting in a tool holder), a robot controller (not shown) directs the master-side assembly 20 to mechanically couple to the tool-side assembly 30, thus attaching the tool T to the robot. Similarly, when the tool Tis safely disposed in a tool stand after a robotic operation, the robot controller directs the master-side assembly 20 to decouple from the tool-side assembly 30, thereby allowing the robot to move to, and attach, a different tool T.

In some robotic operations—for example, those in which robotic tools are rarely, if ever, changed—manually actuated robotic tool changers are safely utilized with industrial robots. In these situations, the robot arm R is typically parked in a “safe” position. Its automatic actuation is then disabled while a person attaches or detaches a tool T. Both automatic and manually actuated robotic tool changers facilitate the provision of utilities—such as electrical current, air pressure, hydraulic fluid, cooling water, and the like—to the tool(s) T, and the transfer of data from some tools T back to the robotic controller.

The locking mechanism 40 is configured to move between a locked position and an unlocked position responsive to the pivoting movement of locking lever 42, which in this embodiment is formed as a lever, and functions to lock and unlock the master-side and tool-side assemblies 20, 30 to and from each other. The locking mechanism 40 will be described in more detail later. Generally, however, pivoting locking lever 42 towards the robotic tool changer 10 locks the master-side and tool-side assemblies 20, 30 together. In this locked position, locking mechanism 40 greatly reduces or minimizes undesirable movement, such as torsional freeplay about a z-axis of the robotic tool changer 10, and enhances torsional stiffness. Pivoting locking lever 42 in the opposite direction away from the robotic tool changer 10 unlocks the master-side and tool-side assemblies 20, 30, thereby allowing the assemblies 20, 30 to be freely separated from each other.

The integrated F/T sensor 80 may be positioned at different locations on or within the robotic tool changer 10 depending on the embodiment. Thus, as explained in more detail below, the present disclosure considers both “single-body” and “dual-body” embodiments. For example, with “dual-body” embodiments, the integrated F/T sensor 80 is an independent component, separate from both the master-side and tool-side assemblies 20, 30, that releasably couples to/mates with either the master-side assembly 20 or the tool-side assembly 30 via one or more mechanical fasteners. When coupled to the master-side assembly 20, the F/T sensor 80 is disposed between the master-side assembly 20 and a terminal end of the robot arm R. Additionally, the F/T sensor 80 is in direct contact with the terminal end of robot arm R such that a surface of the F/T sensor 80 directly contacts a surface of the robot arm R. When coupled to the tool-side assembly 30, however, the F/T sensor 80 is disposed between the tool-side assembly 30 and the one or more tools T used by the robot. Further, in this embodiment, the F/T sensor 80 may be in direct contact with the tool T.

With “single-body” embodiments, the F/T sensor 80 is an integral component of either the master-side assembly 20 or the tool-side assembly 30. In these embodiments, the integrated F/T sensor 80 is not a separate component independent of the master-side and tool-side assemblies 20, 30. Nor is it coupled to the master-side or tool-side assemblies 20, 30 via mechanical fasteners, as described above. Rather, either the master-side assembly 20 or the tool-side assembly 30 is manufactured to comprise the integrated F/T sensor 80. For example, the F/T sensor 80 may be milled into the master-side or tool-side assembly 20, 30 during the manufacturing process such that the F/T sensor 80, along with locking mechanism 40 and the master-side or tool-side assembly 20, 30 into which it was milled, form a unitary member.

In such “single-body” embodiments, the master-side or tool-side assembly 20, 30 and the integrated F/T sensor 80 may be manufactured from a single piece of metal or metal alloy using any technique known in the art. However, those of ordinary skill in the art should readily appreciate that the present disclosure is not limited simply to milling the master-side or tool-side assemblies 20, 30 to include an integrated F/T sensor 80. In other embodiments, for example, the F/T sensor 80 and the master-side or tool-side assemblies 20, 30 are manufactured separately as independent components and then bonded together by welding or other such means to create a single unitary member.

It should be noted that, in the context of the present embodiments, the term “integrated” means that separate or independent components, such as the F/T sensor 80, the locking mechanism 40, and either the master-side assembly 20 or the tool-side assembly 30, are combined into a harmonious, interrelated whole. The term “unitary” means that the F/T sensor 80, the locking mechanism 40, and the master-side or tool-side assembly 20, 30 into which the F/T sensor 80 and locking mechanism 40 are integrated are not physically separable components. This is regardless of whether the F/T sensor 80, the locking mechanism, and the master-side or tool-side assembly 20, 30 into which they is integrated are manufactured from a single piece of metal or metal alloy (e.g., by milling), or whether they are manufactured separately and subsequently bonded together to form the unitary member.

Additionally, the present disclosure uses the terms “master” and “tool” to denote specific components in the robotic tool changer 10. However, in any particular application, the mountings of these components may be reversed. Accordingly, as used herein, the terms “master” and “tool” are terms of reference only.

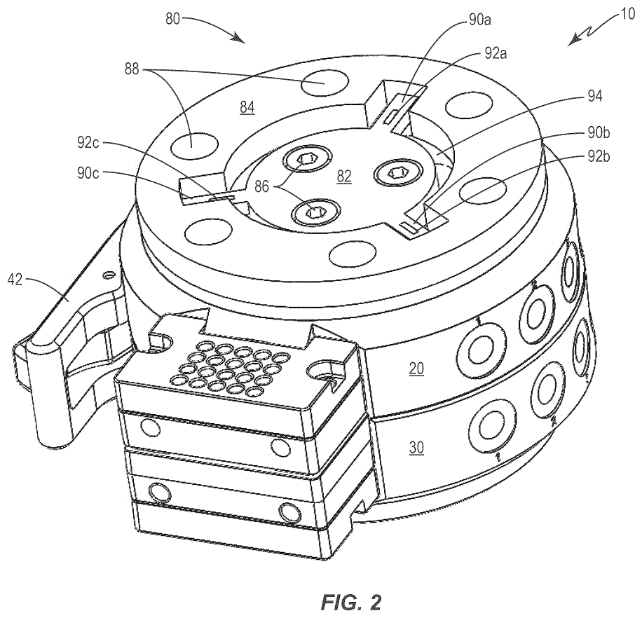

FIG. 2 illustrates a dual-body embodiment of the robotic tool changer 10 as seen from the master-side assembly 20. In this embodiment, F/T sensor 80 comprises a central hub 82 and an interface 84 disposed annularly around, and spaced apart from, central hub 82. Both the central hub 82 and the interface 84 comprise a plurality of respective through-holes 86, 88. Each through-hole 86 is sized and shaped to receive a mechanical fastener, such as a bolt, for example, that mechanically couples the F/T sensor 80 to the master-side assembly 20, thereby integrating the F/T sensor 80 with the master-side assembly 20. Similarly, each through-hole 88 in interface 84 is sized and shaped to receive a mechanical faster that mechanically couples the F/T sensor 80 to the terminal end of the robotic arm R. Accordingly, not only does the integrated F/T sensor 80 of the present embodiments function to detect and report the changes in the force and/or torque applied to the robotic tool changer 10, but it is also configured to mechanically couple directly to the robotic arm R, thereby functioning as a mounting interface that releasably connects the master-side assembly 20 of the robotic tool changer 10 to the terminal end of robotic arm R.

The F/T sensor 80 also comprises a plurality of elastically deformable sensing structures, also referred to herein as “beams” 90a, 90b, 90c, and one or more transducers 92a, 92b, 92c, each affixed to a surface of a corresponding one of the beams 90a, 90b, and 90c. Although such an orientation is not specifically required by the present disclosure, each beam 90a, 90b, 90c in this embodiment extends radially outward from central hub 82 and connects to an inner surface of interface 84. In other embodiments, seen later in more detail, the beams 90a, 90b, 90c extend vertically between interface 84 and a surface of the master-side assembly 20.

In operation, each beam 90a, 90b, 90c deforms under load. Each transducer 92a, 92b, 92c, which may be a foil or semiconductor/piezoresistive-based strain gauge, for example, detects the strain on the beams 90a, 90b, 90c caused by an applied force. Detecting such strain may be accomplished, for example, by detecting the changes in resistance as the load deforming the beams 90a, 90b, 90c changes. Thus, in this embodiment, each transducer 92a, 92b, 92c uses a Wheatstone bridge to convert the changes in resistance detected by the transducers 92a, 92b, 92c to changes in voltage. The voltage changes are then converted into electrical signals for output to processing circuitry, such as a measurement circuit, for example.

According to the present disclosure, the electrical signals generated by transducers 92a, 92b, 92c may be analog voltage signals, or they may be digital signals that are generated, for example, by utilizing an analog to digital signal converter. Regardless of their particular form, however, the electrical signals generated by transducers 92a, 92b, 92c may represent calculated forces and/or torques, or they may simply be raw signal data sent to a processing circuit for use in the calculation of these forces and/or torques.

In this embodiment, each beam 90a, 90b, 90c extends between the central hub 82 and a surface of the sidewall of interface 84. However, the central hub 82 is separated from interface 84 using one of two methods. The first method machines around elastically deformable beams 90a, 90b, 90c, and central hub 82 effectively “carving out” one or more separations 94. In this embodiment, there are three such separations 94; however, there may be more or fewer separations 94 as needed or desired. The second method employs interface 84 as a distinct body that is specifically engineered to be directly affixed to the master-side assembly 20 of the robotic tool changer 10. This separate body is designed to integrate seamlessly with the master-side assembly 20 and the robot arm R, thereby ensuring a cohesive and functional assembly with a reduced stack height as compared to the master-side assembly 20 and the interface 84 on their own.

As stated above, the transducers 92a, 92b, 92c may comprise foil or semiconductor/piezoresistive-based strain gauges to detect the deformation of the beams 90a, 90b, 90c under a load. However, those of ordinary skill in the art should readily appreciate that the present embodiments are not limited solely to these types of strain gauges. The deformation-based sensing can also come from distance sensing in the form of capacitance sensors, SAW (Surface Acoustic Wave), FBG (Fiber Bragg Grating), or Optical sensors. Specifically, for a capacitance sensor, the sensing structures directionally deflect under load. The non-contact capacitance sensors can then detect a change in capacitance due to a changing gap between them. For a SAW/FBG/optical sensing element, the changing distance causes an analog signal to be picked up, which can then be processed into resolved forces and torques in a digital or analog signal.

As those skilled in the art will appreciate, the number of elastically deformable sensing structures (e.g., beams 90a, 90b, 90c) and/or transducers 92a, 92b, 92c seen in FIG. 2 is merely illustrative. Typically, however, an F/T sensor 80 configured according to the present embodiments will have at least three beams 90a, 90b, 90c but can have more (e.g., up to six). Similarly, an F/T sensor 80 will typically have at least one transducer 92 affixed to each beam 90 but can have multiple transducers 92 affixed to each beam 90. As seen in later embodiments, for example, any given beam 90a, 90b, 90c of an F/T sensor 80 configured according to the present disclosure may have two or more transducers 92 affixed to its surface.

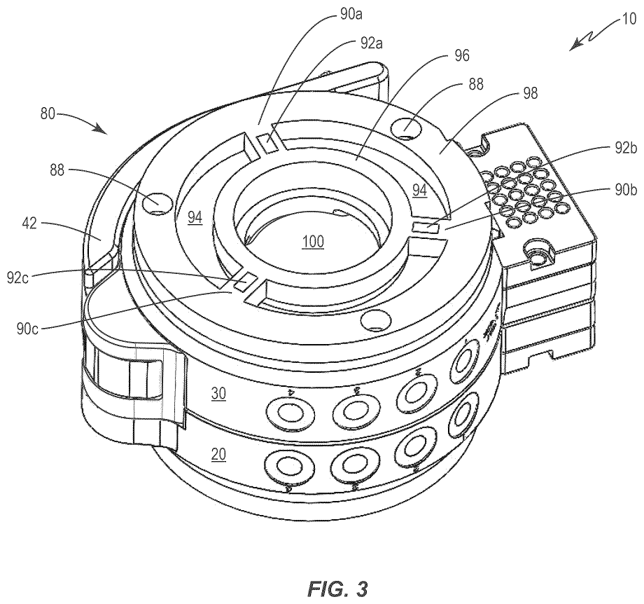

FIG. 3 illustrates another dual-body embodiment of the robotic tool changer 10 having an integrated F/T sensor 80 as seen from the tool-side assembly 30. Particularly, in this embodiment, the tool-side assembly 30 and the F/T sensor 80 are manufactured as separate, independent components and then mechanically coupled together using one or more mechanical fasteners. As seen in FIG. 3, the structure of an F/T sensor 80 integrated with the tool-side assembly 30 is different than an F/T sensor 80 integrated with the master-side assembly 20 seen in FIG. 2. Specifically, the F/T sensor 80 of FIG. 3 comprises a central hub 96 formed as a ring that surrounds, and defines, a central chamber 100 configured to receive at least a portion of a tool T used by the robot. Additionally, F/T sensor 80 of FIG. 3 also comprises an interface 98 formed as a concentric ring disposed annularly around, and spaced apart from, the central hub 96. A plurality of through-holes 88 formed in the interface 98 enables the F/T sensor 80, and the tool-side assembly 30 with which it is integrated, to be securely mechanically fastened to a desired tool used by the robot.

The central hub 96 is separated from interface 98 either by machining around the elastically deformable beams 90a, 90b, 90c, thereby effectively carving out separations 94, or by engineering the F/T sensor 80 to be directly coupled to the tool-side assembly 30 of the robotic tool changer 10. In this latter method, interface 98 comprises a distinct body specifically engineered to be directly affixed to the tool-side assembly 30 of the robotic tool changer 10. This separate body is designed to integrate seamlessly with the tool-side assembly 30 and the robot arm R, thereby ensuring a cohesive and functional assembly with a reduced stack height as compared to the master-side assembly 20 and the interface 98 on their own. Regardless of its structure, however, the F/T sensor 80 integrated with the tool-side assembly 30 seen in FIG. 3 provides the same or similar functionality as that of the F/T sensor 80 integrated with the master-side assembly 20, as seen in FIG. 2—i.e., to detect deformation of the beams 90a, 90b, 90c under a load and to securely mount the tool-side assembly 30 of the robotic tool changer 10 to a desired tool to be utilized by the robot.

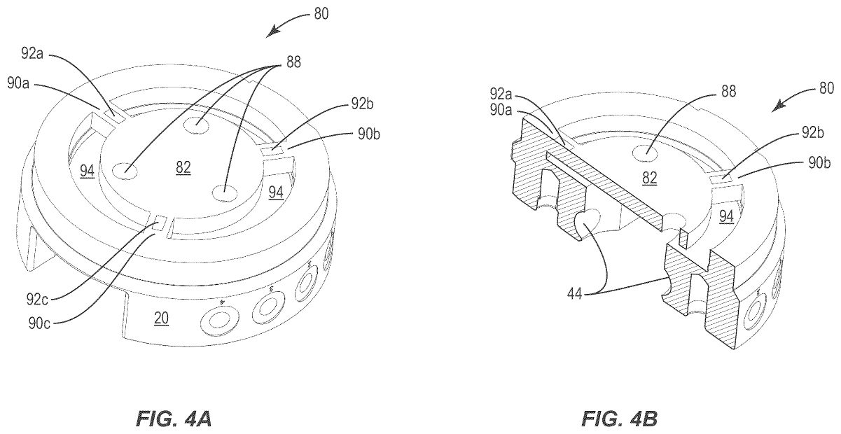

As previously stated, the present disclosure is not limited solely to dual-body implementations. Rather, the present disclosure also provides a single-body embodiment in which the integrated F/T sensor 80 and the locking mechanism 40 are integrated into either the master-side assembly 20 or the tool-side assembly 30 such that they form a unitary member. FIGS. 4A-4B are a perspective view and a plan view, respectively, of one such unitary embodiment with respect to the master-side assembly 20. Particularly, the master-side assembly 20 and the integrated F/T sensor 80 are manufactured from a single piece of metal or metal alloy. Although such machining may be accomplished using any techniques known in the art, the master-side assembly 20 and the integrated F/T sensor 80 of this embodiment are manufactured by machining around the elastically deformable beams 90a, 90b, 90c and central hub 82, thereby effectively carving out separations 94.

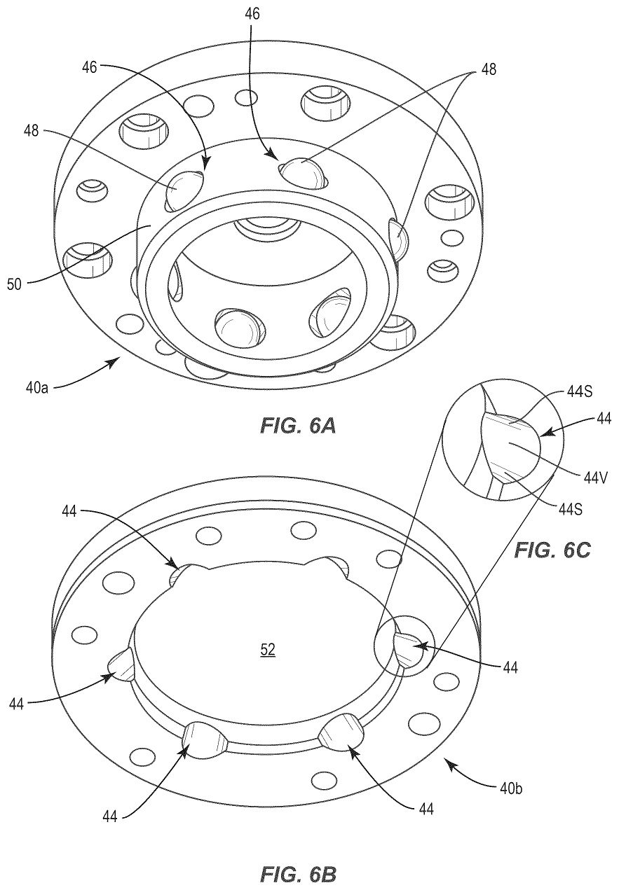

Additionally, as best seen in FIG. 4B, the master-side assembly 20 comprises a part of the locking mechanism 40. Specifically, this embodiment of the master-side assembly 20 is configured to receive a bearing race (seen in FIG. 6B). As described in more detail later, the bearing race comprises one or more circumferentially spaced scalloped cutouts or pockets 44 machined on its inner surface. Each cutout 44 is sized and shaped to receive a corresponding spherical rolling member (e.g., a ball bearing) that is associated with the part of locking mechanism 40 integrated with the tool-side assembly 30. It should be noted here that the bearing race may comprise a separate component independent of the master-side assembly 20, or it may be manufactured with the master-side assembly 20 and/or the F/T sensor 80 as a single, unitary piece, as previously described.

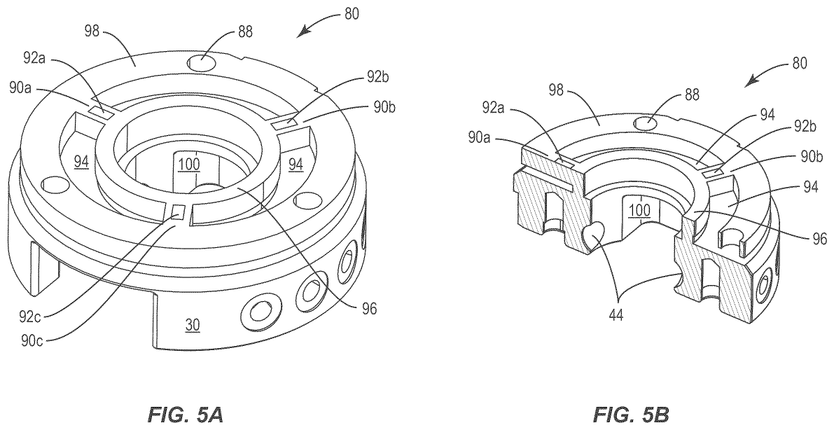

FIGS. 5A-5B are a perspective view and a plan view, respectively, of a unitary (i.e., single-body) embodiment with respect to the tool-side assembly 30. This embodiment of the tool-side assembly 30 and the integrated F/T sensor 80 are machined from a single piece of metal or metal alloy, as previously described. Such machining may be accomplished using any techniques known in the art; however, in this embodiment, the tool-side assembly 30 and the integrated F/T sensor 80 are manufactured by machining around the elastically deformable beams 90a, 90b, 90c and central hub 96, thereby effectively carving out separations 94 between central hub 96 and interface 98. The central chamber 100 may be formed in the same manner.

Additionally, as best seen in FIG. 5B, the tool-side assembly 30 also comprises a part of locking mechanism 40. In this embodiment, the tool-side assembly 30 is configured to receive the bearing race. As described above, the surface of the bearing race is machined to include one or more circumferentially spaced scalloped cutouts or pockets 44—each of which is sized and shaped to receive a corresponding spherical rolling member associated with the part of locking mechanism 40 that is integrated with the master-side assembly 20. As above, the bearing race may comprise a separate component independent of the tool-side assembly 30, or it may be manufactured with the tool-side assembly 30 and/or the F/T sensor 80 as a single, unitary piece, as previously described.

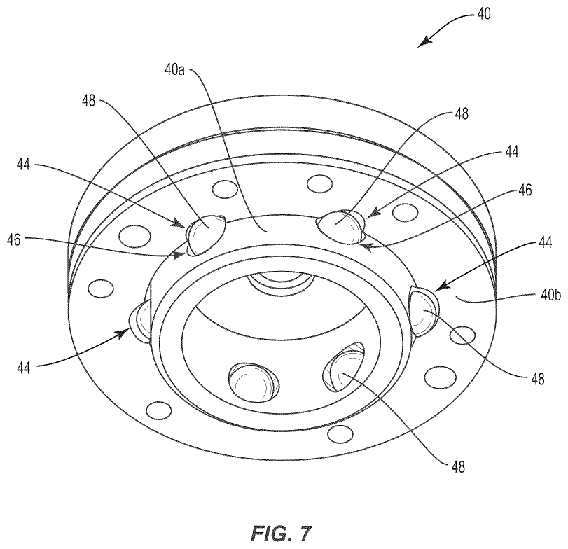

FIGS. 6A-6C illustrate components of a locking mechanism 40, while FIG. 7 illustrates those components mated together according to embodiments of the present disclosure. More particularly, as seen in FIGS. 6A and 6B, locking mechanism 40 comprises two parts—a collar 40a and a bearing race 40b. In this embodiment, collar 40a is integrated with the tool-side assembly 30 and bearing race 40b is integrated with the master-side assembly 20. However, those of ordinary skill in the art should readily appreciate that this is merely for ease of discussion, as the present disclosure is not limited to this particular integration of collar and bearing race 40a, 40b. In another embodiment, for example, the collar 40a may be integrated with the master-side assembly 20 and the bearing race 40b is integrated with the tool-side assembly 30.

Regardless of their particular arrangement, however, the collar 40a in this embodiment includes an annular ring 50. A plurality of bores 46 are formed in a sidewall of the annular ring 50 and contain a corresponding plurality of rolling members 48. In this embodiment, the collar 40a has six bores 46 and six rolling members 48; however, the number of bores 46 and rolling members 48 can vary as needed or desired. Bores 46 are circumferentially spaced around collar 40a and are arranged such that pairs of bores 46 are aligned. Hence, pairs of the rolling members 48 are also aligned.

As also shown in FIG. 6B, bearing race 40b defines an interior chamber 52 that is sized and shaped to receive collar 50. Additionally, the scalloped cutouts 44 are circumferentially spaced around the bearing race 40b and are also pair-wise aligned. Hence, when the locking lever 42 is pivoted towards the robotic tool changer 10, the rolling members 48 are forcibly projected outwardly from the collar 40a to contact portions of scalloped cutouts 44. In some cases, at least some of the rolling members 48 may not seat squarely in the center of their corresponding scalloped cutouts 44. That is, some of the rolling members 48 may be slightly misaligned with the scalloped cutouts 44.

As seen in FIG. 6C, each scalloped cutout 44 includes a valley 44V and opposed sloped surfaces 44S extending from the valley 44V. More particularly, valley 44V lies in the center of the scalloped cutout 44, while the sloped surfaces 44S lie on each side of the valley 44V. Facing one of the cutouts 44 as a point of reference, one of the sloped surfaces 44S is referred to as the “left” sloped surface and the other sloped surface is referred to as the “right” sloped surface. The term “opposed sloped surface” or “opposing sloped surfaces” refers to the left and right sloped surfaces 44S of a given cutout 44. In the illustrated embodiments, sloped surfaces 40S are curved. Additionally, the radius of that curvature can vary. However, according to the present disclosure, the radius of curvature must be sufficient for the rolling members 48 to contact the sloped surfaces 44S of a corresponding cutout 44, and at the same time, to be at least slightly offset with respect to the center of the cutout 44. As discussed further below, the robotic tool changer 10 is designed such that at least some of the rolling members 48 engage and contact the sloped surfaces 44S—not the valley 44V—when the master-side and tool-side assemblies 20, 30 are coupled.

FIG. 7 illustrates an embodiment of locking mechanism 40 in which the collar 40a is mated with the bearing race 40b when the master-side and tool-side assemblies 20, 30 are releasably coupled together. As previously stated, collar 40a is integrated with the tool-side assembly 30 and includes rolling members 48 that are movable within bores 46. The bearing race 40b, which is formed as an annular ring, defines the interior chamber 52 configured to receive collar 50. When mated, collar 40a fits within the interior chamber 52. Two of the rolling members 48 contact the right sloped surface 40S of opposing cutouts 44 while two other rolling members 48 contact the left sloped surface 40S of other opposing cutouts 44. To provide for this contact pattern, some of the bores 46 formed in collar 40a and their rolling members 48 are misaligned with target cutouts. In the context of this disclosure, a target cutout is a cutout 44 that is the object of a rolling member 48 during coupling. When seated on one of these sloped surfaces 44S of a cutout 44, the rolling member 48 is slightly offset with respect to the valley 44V of the cutout 44. Since the left and right sloped surfaces 44S of a plurality of cutouts 44 are contacted by multiple rolling members 48, relative rotation between the master-side and tool-side assemblies 20, 30 is prevented or minimized. This contributes to the torsional stiffness of the robotic tool changer 10.

The previous embodiments describe the locking lever 42 as being movable between the locked and unlocked positions. Such movement may be accomplished, for example, by a user manually operating the locking lever 42. However, the present disclosure is not limited solely to manual actuation of the locking mechanism 40. In other embodiments, for example, locking mechanism 40 may be operated according to any of a pneumatic force, electric force, or biasing force. Regardless, though, the rolling members 48 comprise spherical members configured to move within their corresponding bores 46 between the locked and unlocked positions responsive to one or more of those forces.

Further, the present embodiments are not limited solely to relying on locking mechanism 40 to ensure that the master-side and tool-side assemblies securely couple together. In some cases, an energy outage may cause the locking mechanism to unlock prematurely. Therefore, the present embodiments also contemplate a secondary “safety” lock that will keep the master-side and tool-side assemblies 20, 30 coupled together in case of a failure of the locking mechanism 40 (e.g., in response to a loss of power).

Further, the present embodiments are not limited solely to the type of locking mechanism seen in the figures. Rather, the present embodiments may also utilize other types of locking mechanisms that facilitate maintaining a stiff connection. Such mechanisms may include, but are not limited to, a pin-type locking mechanism, and may also be beneficial for use as a secondary safety lock, as previously described.

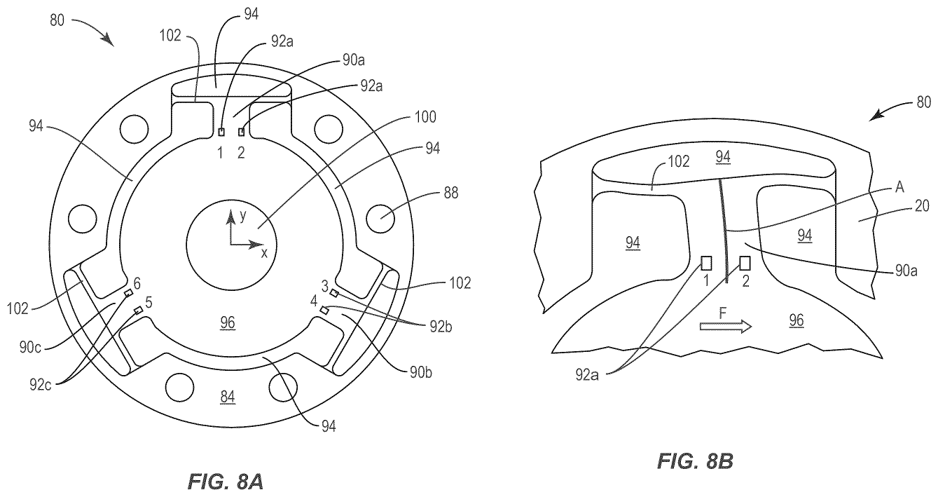

Additionally, those of ordinary skill in the art should understand that the F/T sensor 80 of the present disclosure is not limited solely to the previously illustrated structure. Rather, as seen in FIGS. 8A-8B, for example, F/T sensor 80 may be structurally different from the previously described embodiments, and yet, remain suitable for integration within the master-side and/or tool-side assemblies 20, 30 according to the present embodiments.

FIG. 8A, for example, illustrates a plan view of a F/T sensor 80 according to one embodiment of the present invention. As seen in FIG. 8A, the central hub 96 of the tool-side assembly 30 is connected to the interface 84 of the master-side assembly 20 by the three elastically deformable beams 90a, 90b, 90c. In the embodiment depicted, each beam 90a, 90b, 90c connects directly to the central hub 96, and connects to the interface 84 via flexures 102, which aid in the deformation of the beams 90 under mechanical loading. The central hub 96 is configured to be connected to a first object, such as a robotic tool T, via central chamber 100 and/or by tapped holes in the underside of the F/T sensor 80 (not shown in this figure). The interface 84 is configured to be connected to a second object, such as the robotic arm R, via a plurality of mechanical fasteners extending through corresponding through-holes 88. Although not clear from this view, the central hub 96 and the interface 84 are only connected by the flexures 102.

Affixed to (only) the upper surface of each beam 90a, 90b, 90c are pairs of transducers 92a, 92b, 92c (e.g., strain gauges). In this embodiment, there are three pairs of transducers 92a, 92b, 92c, which as a reference for later discussion, are numbered 1-6. Particularly, transducers 1 and 2 in a first pair of transducers 92a are affixed to beam 90a; transducers 3 and 4 in a second pair of transducers 92b are affixed to beam 90b, and transducers 5 and 6 in a third pair of transducers 92c are affixed to beam 90c. However, more or fewer pairs of transducers may be included.

FIG. 8A also depicts two axes of a 3-dimensional reference Cartesian coordinate system (z-direction extending out of the figure), which will be used to unambiguously label forces and torques in the ensuing disclosure. Although not depicted in FIG. 8A, the F/T sensor 80 may include a processing circuit operative to receive electrical signals from each transducer 1-6, and to process the signals to resolve the magnitude and direction of force(s) and torque(s) applied between the interface 84 and central hub 96. Such processing circuits may comprise, e.g., one or more microprocessors coupled to memory operative to store program code and sensor data.

FIG. 8B is an enlarged view of one elastically deformable beam 90a undergoing deformation due to a force F applied to the central hub 96 of tool-side assembly 30 relative to interface 84 of master-side assembly 20. This force deforms the beam 90a slightly to the left (the figure is not to scale). A compressive force is induced on the left side surface of beam 90a, and a tensile force is induced on the right side surface of beam 90a. With conventional F/T sensors, transducers (e.g., strain gauges) mounted on these surfaces would generate strong signals of opposite polarity from which the deformation, and hence the applied force F, could be ascertained. However, the two sides of the upper surface of the beam 90a also experience the compressive and tensile strain in a magnitude that increases with distance away from a neutral axis A. The neutral axis A is the line, running generally longitudinally down the center of the upper surface of the beam 90a, at which compressive strain experienced on the left side of the beam 90a transitions to tensile strain on the right side of beam 90a. Accordingly, the beam 90a undergoes no strain at the neutral axis A.

In this embodiment, a pair of transducers 1, 2 is affixed to only the upper surface of beam 90a. The pair of transducers 1, 2 are located to either side of, and spaced apart from, the neutral axis A. Differential signals, such as signals having opposite polarities, from the pair of transducers 1, 2, indicate bending of the beam 90a in the plane of the upper surface (Tz, Fxy) (i.e., Torque in the z-plane and Force in the x-y plane). Common-mode signals (i.e., signals having the same polarity) indicate bending of the beam 90a in the z-plane (i.e., caused by Fz, Txy) (i.e., Force in the z-plane and Torque in the x-y plane).

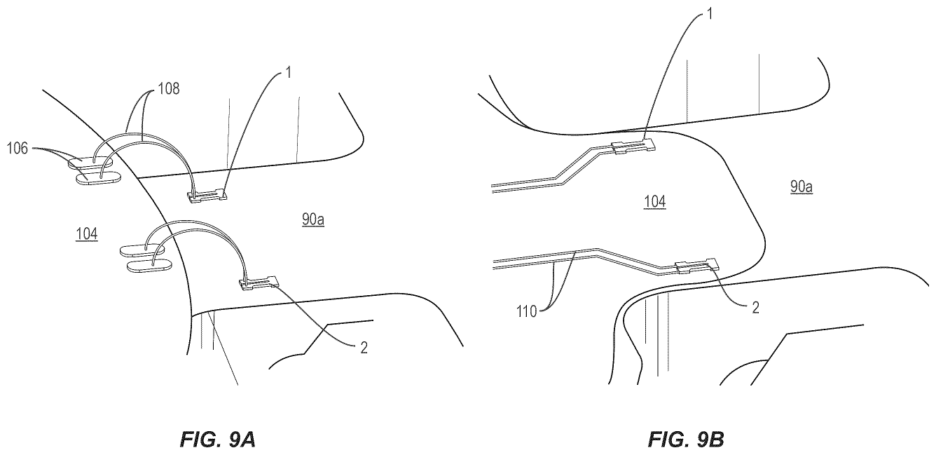

As stated previously, each individual transducer 1-6 is electrically connected to a processing circuit that may be co-located with, or remote from, the robotic arm R. For example, in one embodiment depicted in FIG. 9A, transducers 1 and 2 (without bond wires) are attached to the beams 90 by conventional means (e.g., manually, with epoxy). A printed circuit board (PCB) 104 with wirepads 106 is adhered to the surface of central hub 96. Electrical connections (e.g., via bond wires 108) are then formed directly between the transducers 1 and 2 and wirepads 106 with a wirebonding machine, eliminating all manual handling of bond wires 108. As is well-known in the electronic arts, automated wirebonding is faster, more accurate, and cheaper than manual wiring.

In another embodiment, as depicted in FIG. 9B, transducers 1 and 2 are mounted, with solder pads, face down onto surface mount device (SMD) pads on a flexible circuit substrate 104 (e.g., a Printed Circuit Board (PCB) such as polyimide film). The flexible circuit substrate 104 is adhered to the body of F/T sensor 80, such as over central hub 96, and has tabs that extend at least partially onto the top surface of beam 90a. The transducers 1 and 2 are populated on the flexible circuit substrate 104, along with all other circuit components, by a pick-and-place machine and reflowed to solder them down. The SMD pads are connected to other electronics by pre-formed circuit traces 110, e.g., copper, on the PCB 104. This eliminates all gauge wiring, at the cost of reduced signal magnitude (e.g., lower signal to noise ratio) due to flexing in the polyimide material. In this embodiment, both manual attachment and wiring of the transducers 1 and 2 are eliminated, achieving cost reduction and increased quality, uniformity, and production speed.

It should be noted here that FIGS. 9A-9B illustrate the present embodiments showing only two transducers (i.e., transducers 1 and 2 on beam 90a). However, FIGS. 9A and 9B, along with their corresponding descriptions, apply equally to all transducers 92 affixed to all beams 90.

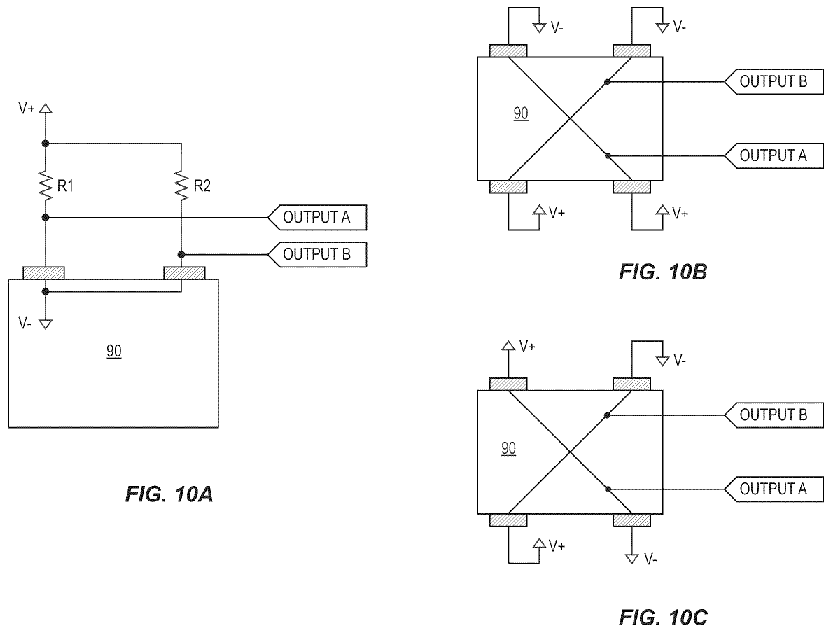

In one embodiment, the pairs of transducers 1-2, 3-4, 5-6 on each beam 90a, 90b, 90c, respectively, is wired in a quarter bridge topology, using two fixed resistors R1, R2, as depicted in FIG. 10A. The six transducers 1-6, affixed to beams 90a, 90b, 90c as depicted in FIG. 10A, generate the following signals under the six applied forces and torques, using the reference Cartesian coordinate system of FIG. 8A. In the following table, a strong tensile force is denoted by “T,” a weak tensile force by “t,” a strong compressive force by “C,” and a weak compressive force by “c.”

TABLE 1

| | Force X | Force Y | Force Z | Torque X | Torque Y | Torque Z |
|---|---|---|---|---|---|---|
| Gage 1 | C | none | T | T | none | T |
| Gage 2 | T | none | T | T | none | C |
| Gage 3 | t | T | T | c | C | T |
| Gage 4 | c | C | T | C | C | C |
| Gage 5 | t | C | T | C | T | T |
| Gage 6 | c | T | T | c | T | C |

It is clear by inspection of Table 1 that the signals generated under each loading condition follow unique patterns, and can therefore be resolved into forces and torques by a known calibration matrix process.

FIGS. 10B-10C illustrate an embodiment where the applied forces/torques detected by F/T sensor 80 are applied for a duration that is longer than merely instantaneous. Particularly, in this embodiment, a switching circuit first applies the excitation polarity of FIG. 10B, and obtains zero-sum signals for all axes other than Fz. The applied excitation voltage is then switched to the configuration depicted in FIG. 10C, and a zero-sum reading is obtained for Fz, while Tz generates the non-zero-sum signals. In this manner, zero-sum equations are applied to all six force/torque axes, and all common-mode signals, such as temperature-induced errors, are eliminated. This eliminates the need for a dedicated temperature compensation strain gauge (and mathematical elimination of the error), or the need to fabricate a non-stressed mounting point for the temperature compensation gauge.

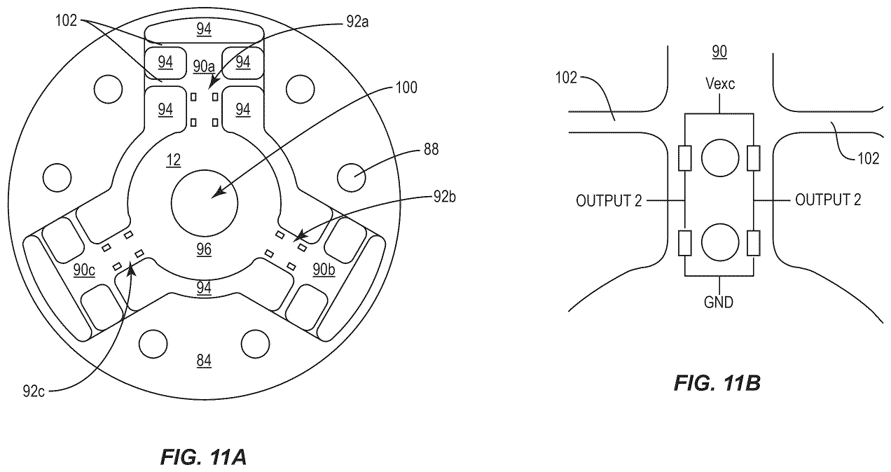

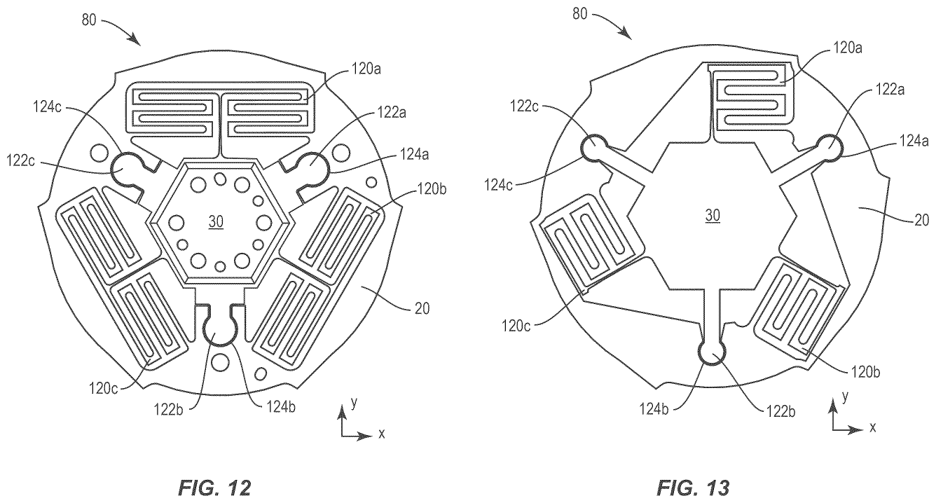

While the previous embodiments show a pair of transducers affixed to a beam 90, the present disclosure is not so limited. In some embodiments, multiple pairs of transducers (e.g., strain gauges) may be affixed to a given beam 90. FIG. 11A, for example, depicts an integrated F/T sensor 80 in which two pairs of transducers 92 (e.g., strain gauges) are affixed to the top surface only of each beam 90. As in the single transducer pair embodiments, the two pair transducers are each affixed to the top surface only of the beam 90, on either side of, and spaced apart from, the neutral axis A of the beam 90. In some embodiments, a strain-concentrating hole may be formed through the beam 90, between each pair of strain gages.

In this embodiment, multiple flexures 102 on each beam 90 prevent significant compressive and tensile beam loading, while largely preventing rotation at the free end of the beams 90. This causes the beams 90 to deform in shear under all loading conditions. Thus, the transducers, when electrically connected as shown in FIG. 11B, always are strained by approximately equal amounts but in the opposite direction (tension/compression) under all loading conditions. The mechanical design of this embodiment presents some added complexity but can be manufactured by the same process and tools as discussed with respect to the previous embodiments, and it additionally results in an increase in overall stiffness.

It should also be understood that the present embodiments are not limited to affixing transducers to one surface of a beam 90. Rather, in some embodiments, it is beneficial to mount transducers on both the top and bottom surface of each beam 90. In other embodiments, transducers, or pairs of transducers, may be affixed to a surface on the side of a given beam 90. Further, the present disclosure does not limit an F/T sensor 80 to including only one type of transducer 92 (e.g., all beams 90 have the same type of strain gauge affixed thereto). Rather, in some embodiments, a first type of transducer may be affixed to a first beam while a second, different type of transducer may be affixed to a second, different beam 90.

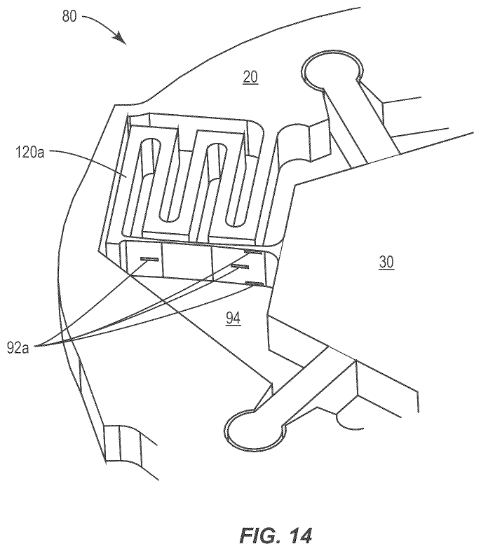

Nor is the present disclosure limited to the size and/or shape of the deformable beams 90. According to some embodiments, as depicted for example in FIGS. 12-14, the length of the deformable beams 90 is increased by forming a serpentine deformable beam 90. As used herein, the term “serpentine” means a shape that deviates from a straight line by curving or bending alternately to one side and then the other. In other words, a directed path taken down the centerline of the serpentine deformable beam, along its length from a point of attachment to the tool-side assembly 30 to a point of attachment to the master-side assembly 20 (or vice versa), deviates from being a straight line by turning, curving, or angling at least once to the left (or right), and then further deviates from being a straight line by turning, curving, or angling at least once to the right (or left). Of course, the serpentine deformable beam may deviate to both the left and right numerous times along its extent from the tool-side assembly 30 to a point of attachment to the master-side assembly 20. The alternate deviations need not be consecutive—that is, the serpentine deformable beam may make a plurality of turns to the same direction, and then make a turn to the opposite direction. The deviation from a straight line may be in the form of a sharp angle, or may be a gradual curve. Note that a directed path which experiences only one deviation from straight line, i.e., to the left or the right, but not both (such as the deformable beams 90 of the previously described embodiments) is not encompassed within the meaning of “serpentine” as that term is used herein.

In one embodiment, the serpentine deformable beam may comprise a plurality of straight beam segments connected at various angles, and some of these segments may run parallel to each other, so as to achieve a greater total deformable beam length, while confining the serpentine deformable beam to a small space. In some embodiments, a segment or portion of the serpentine deformable beam may “fold back,” or run in a direction opposite to a prior segment or portion of the beam.

FIG. 12 depicts a force/torque sensor 80, comprising a tool-side assembly 30, which may be connected to a tool T, and a master-side assembly 20, which may be connected to a robotic arm R (or vice versa). The master-side assembly 20 is arranged generally annularly around the tool-side assembly 30. A plurality of serpentine deformable beams 120a, 102b, 120c, each comprising a plurality of deformable beam segments connected at angles, connect the tool-side assembly 30 to the master-side assembly 20. In the embodiment depicted in FIG. 12, each serpentine deformable beam 120a, 120b, 120c includes a first portion that connects to the tool-side assembly 30. This first portion then connects, via a “T” connection, to a second portion. At each end of the second portion, the serpentine deformable beam then “folds” in a serpentine manner. Each of these serpentine sections then connects to the master-side assembly 20. Accordingly, in this embodiment, each serpentine deformable beam 120 includes two separate directed paths from the point of attachment to the tool-side assembly 30, to two different points of attachments to the master-side assembly 20. Each of these directed paths define a serpentine shape, as that term is defined and used herein.

Due to their extended overall length, the serpentine deformable beams 120 allow slight relative motion between the tool-side assembly 30 and master-side assembly 20, in the x-y plane as well as in the z-direction (out of the paper) with a relatively low stiffness. That is, the F/T sensor 80 has a greater degree of “looseness” or “play” within its operating range than, for example, a comparably sized sensor with the straight-line or T-shaped deformable beams of the prior art designs depicted in the previous embodiments. The serpentine deformable beams 120 are instrumented with transducers (e.g., strain gages—not shown) on one or more sides, which transduce compressive and tensile forces at the surface(s) of the serpentine deformable beams 120 into electrical signals. The strain gages may be wired in a full-, half-, or quarter-Wheatstone bridge configurations, as known in the art. A data acquisition and processing system (not shown) processes the transducer outputs to resolve, e.g., six forces and torques acting between the tool-side assembly 30 and master-side assembly 20 (Fx, Fy, Fz, Tx, Ty, Tz), as known in the art.

The F/T sensor 80 also includes a plurality of overload beams 122a, 122b, 122c, extending from the tool-side assembly 30 at a first end to near—but not touching—the master-side assembly 20 at a second end (or vice versa). The overload beams 122 are radially interspersed between the serpentine deformable beams 120. A narrow overload gap 124a, 124b, 124c, for example, from a few tens of thousandths of an inch to a few thousands of an inch, separates each respective overload beam 120a, 120b, 120c from the master-side assembly 20. Indeed, the overload gap 124 defines the second (non-connected) end of each overload beam 122. In some embodiments, the tool-side assembly 30, serpentine deformable beams 120, overload beams 122, and master-side assembly 20 are machined from a single piece of metal, which removes stackup tolerances from the overload feature manufacture.

In one embodiment, each overload gap 124 is substantially circular. With three overload beams 122, as depicted, the circular gap 124 must extend greater than 270-degrees of the circumference of a circle, so it will contact in enough orientations to ensure there are no directions in which the tool-side assembly 30 can travel with a different gap distance. A uniform gap distance, or one which is specifically offset in different directions to allow different activation distances in Fxy/Tz, for example with four overload beams, is the driving factor for when the overload beams 118 contact the master-side assembly 20. The exact path the gap 124 follows, i.e., circular, oval, etc., determines the local contact stress when the overload beam 122 contacts the master-side assembly 20. In one embodiment, the overload gaps 124 may be formed using wire electrical discharge machining (EDM), which allows for easy machining of the gaps 124 with tight tolerances. In contrast to the serpentine deformable beams 120, the overload beams 122 are straight, without any bends or angles, and are both shorter and thicker than the serpentine deformable beams 120. Consequently, they exhibit much higher stiffness.

The overload gaps 124 between the overload beams 122 and master-side assembly 20 provide an overload actuation, or stop, for forces (Fxy) and torques (Tz) that move the tool-side assembly 30 relative to the master-side assembly 20 in the x-y plane. To provide an overload stop for motion in the z-direction (out of the page), flat plates are attached above and below the area where each overload beam 122 meets the master-side assembly 20—that is, over and under the overload gaps 124—with shim stock defining a small gap width. Alternatively, the plates covering this area may have a precise step machined into them. Hence, all of the overload stops are created with small gaps and tight tolerances, using readily-available technology that does not threaten to damage the F/T sensor 80, and does not add appreciably to the manufacturing process. One alternate embodiment of overload stop features for the z-direction is to have both flats and a taper machined into plates above and below the sensing element. The flats can be placed closer to the center of the transducer and a taper continues out from the flats so a pure force overload and a torque overload both have large contact areas during an overload event, which reduces contact stresses and again improves fatigue life/strength.

FIG. 13 depicts another embodiment of the F/T sensor 80 according to another embodiment of the present disclosure. In this embodiment, serpentine deformable beams 120a, 120b, 120c are connected between the tool-side assembly 30 and master-side assembly 20. Each serpentine deformable beam 120 in this embodiment is connected to each of the tool-side assembly 30 and master-side assembly 20 at one point only. The serpentine deformable beams 120 are “folded” similarly to the embodiment of FIG. 12, providing an extended overall length but within a small space. The master-side assembly 20 body may take up part of the space occupied by the other “half” of the serpentine deformable beam 120 of the embodiment of FIG. 12, further contributing to post-overload activation stiffness of the overall F/T sensor 80. The overload beams 122a, 122b, 122c and overload gaps 122a, 122b, 122c are constructed as described above.

FIG. 14 shows the details of one serpentine deformable beam 120a of the embodiment of FIG. 13, with a plurality of transducers 92a, such as strain gauges, attached to its side surface. The attachment of transducers 92a may be similar on serpentine deformable beams 120 of the embodiment of FIG. 12. However, the wiring of the transducers 92a is not shown in this figure for clarity. Although shown on one surface, transducers 92a may be attached to the serpentine deformable beams 90, 120 on multiple surfaces (e.g., in pairs on opposite faces), and in any position or orientation.

Although the serpentine deformable beams 120 depicted in FIGS. 12-14 depict parallel runs of lengths of segments of the beams 120, connected at opposite ends to the next successive segment, and thus forming a “fan-folded” shape, this shape is exemplary only and is not limiting.

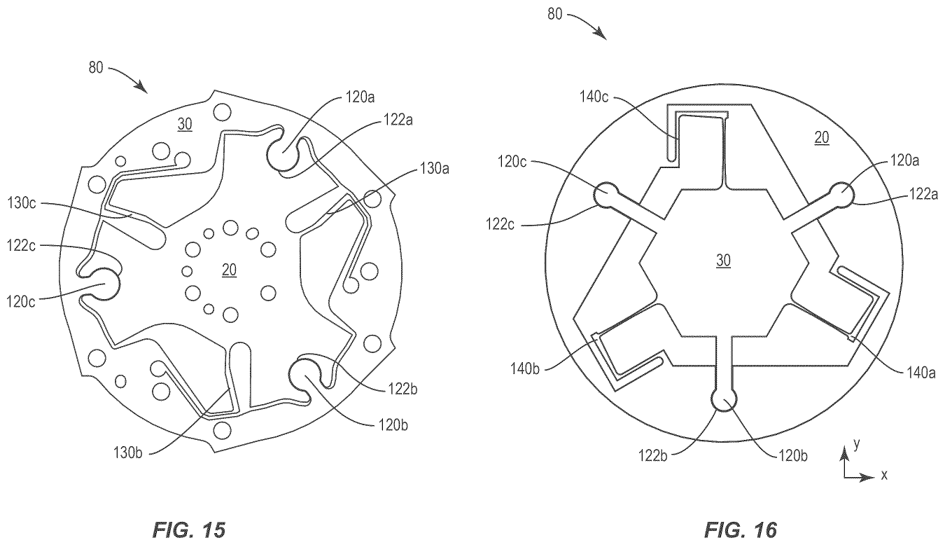

FIG. 15 depicts yet another embodiment of the integrated F/T sensor 80 of the present disclosure with serpentine deformable beams 130a, 130b, 130c. In this case, the serpentine deformable beams 130a, 130b, 130c each exhibit only a slight bend to the left after the attachment point on the tool-side assembly 30, followed by several turns to the right before attaching to the master-side assembly 30. However, because the beams 130 each deviate from a straight line by curving or bending alternately to one side (the left) and then the other (repeatedly to the right), they meet the definition of a “serpentine” beam, as used herein.

FIG. 16 depicts an embodiment of an integrated F/T sensor 80 with spiral deformable beams 140a, 140b, 140c. In this case, the spiral deformable beams 140a, 140b, 140c each exhibit turns to only one side—to the left—for a total of 180-degrees. This exceeds the cumulative minimum total deviations to one side of greater than 90-degrees, according to the definition of spiral deformable beam used herein.

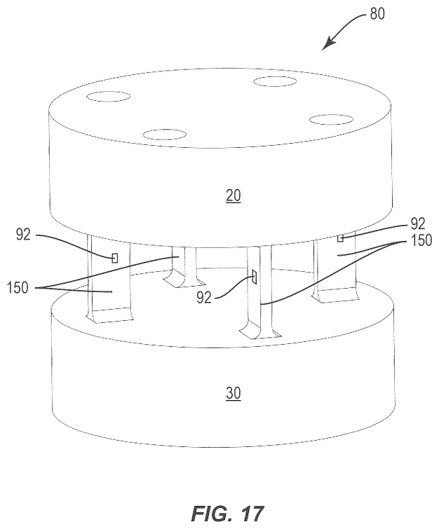

FIG. 17 illustrates an embodiment of an integrated F/T sensor 80 having a plurality of vertically oriented elastically deformable beams 150. As seen in this figure, each deformable beam 150 is attached to, and extends vertically between, the tool-side assembly 30 and the master-side assembly 20. Additionally, one or more transducers 92 are affixed to one or more surfaces of each beam 150. While not explicitly seen in this figure, each transducer 92 is electrically connected to a processing circuit, such as seen in FIGS. 9A-9B, for example, and sends signals representing the magnitude and direction of the forces and torque that caused the deformation of beams 150 to the processing circuit.

Integrating the F/T sensor 80 with the master-side or tool-side assembly 20, 30 provides benefits and advantages not realized with conventional robotic tool changers. For example, a robotic tool changer configured according to the present embodiments reduces stack height. Not only does this reduced stack height allow for a smaller robotic tool changer 10, but it also eliminates or replaces its constituent parts, thereby reducing the size, complexity, and cost of the robotic tool changer 10 and the master-side and tool-side assemblies 20, 30. Additionally, integrating an F/T sensor 80 as provided herein will allow the robot to quickly and easily change between multiple tools, as well detect the forces acting on those tools and on the robotic tool changer.

The present disclosure may, of course, be carried out in other ways than those specifically set forth herein without departing from essential characteristics of the disclosure. The present embodiments are to be considered in all respects as illustrative and not restrictive, and all changes coming within the meaning and equivalency range of the appended claims are intended to be embraced therein.

What is claimed is:

1. A robotic tool changer, comprising:
a master-side assembly configured to couple to a robotic arm;
a tool-side assembly having a first side configured to couple to the master-side assembly and an opposing second side configured to couple to one or more tools used by a robot; and
integrated into one of the master-side assembly and the tool-side assembly:
a locking mechanism configured to move between a locked position and an unlocked position to respectively couple and uncouple the one of the master-side assembly and the tool-side assembly to the other of the master-side assembly and the tool-side assembly; and
a force/torque sensor comprising:
one or more sensing structures configured to elastically deform responsive to an applied force; and
one or more transducers affixed to the one or more sensing structures, wherein each of the one or more transducers is configured to send electrical signals representing a magnitude and a direction of the applied force to a measurement circuit.

2. The robotic tool changer of claim 1, wherein the first side of the tool-side assembly is configured to couple directly to the master-side assembly.

3. The robotic tool changer of claim 2, wherein the force/torque sensor is disposed between the master-side assembly and the robotic arm and is mechanically coupled to the robotic arm such that the force/torque sensor is in direct contact with a terminal end of the robotic arm.

4. The robotic tool changer of claim 2, wherein the force/torque sensor is disposed between the tool-side assembly and a tool used by the robot and is mechanically coupled to the tool such that the force/torque sensor is in direct contact with the tool used by the robot.

5. The robotic tool changer of claim 1, wherein the locking mechanism, the force/torque sensor, and the one of the master-side assembly and the tool-side assembly form a unitary member.

6. The robotic tool changer of claim 1, wherein the force/torque sensor further comprises a central hub and a mounting interface disposed annularly around, and spaced apart from, the central hub.

7. The robotic tool changer of claim 6, wherein each of the one or more sensing structures comprises an elastically deformable beam.

8. The robotic tool changer of claim 7, wherein each of the one or more sensing structures extend radially between the central hub and the mounting interface.

9. The robotic tool changer of claim 7, wherein each of the one or more sensing structures extend vertically.

10. The robotic tool changer of claim 7, wherein the one or more transducers are configured to transduce one or both of tensile strains and compressive strains at a surface of a corresponding elastically deformable beam to the electrical signals sent to the measurement circuit.

11. The robotic tool changer of claim 1, wherein the one or more transducers comprise one or more of:
a strain gauge;
a capacitance sensor;
a Surface Acoustic Wave (SAW) sensor;
a Fiber Bragg Grating (FBG) sensor; and
an optical sensor.

12. The robotic tool changer of claim 1, wherein a first sensing structure comprises a first type of transducer, and wherein a second sensing structure comprises a second type of transducer different than the first type of transducer.

13. The robotic tool changer of claim 1, wherein at least one sensing structure comprises a pair of transducers affixed thereto on opposite sides of, and spaced apart from, a neutral axis of the at least one sensing structure.

14. The robotic tool changer of claim 13, wherein the pair of transducers is affixed to a same surface of the at least one sensing structure.

15. The robotic tool changer of claim 1, wherein the locking mechanism comprises:
a bearing race; and
a movable rolling member configured to move between the locked and unlocked positions and to contact the bearing race in the locked position; and
wherein one of the bearing race and the movable rolling member is formed in the master-side assembly, and the other of the bearing race and the movable rolling member is formed in the tool-side assembly.

16. The robotic tool changer of claim 15, wherein the movable rolling member comprises a spherical member configured to move within a bore between the locked and unlocked positions responsive to one of:
a pneumatic force;
an electric force; and
a biasing force.

17. A master-side assembly for a robotic tool changer, the master-side assembly configured to attach to a robotic arm and a tool-side assembly and comprising:
a locking mechanism configured to move between a locked position and an unlocked position to respectively couple and uncouple the master-side assembly to and from a tool-side assembly of the robotic tool changer; and
a force/torque sensor comprising:
one or more sensing structures configured to elastically deform responsive to an applied force; and
one or more transducers affixed to the one or more sensing structures, wherein each of the one or more transducers is configured to send electrical signals representing a magnitude and a direction of the applied force to a measurement circuit.

18. A tool-side assembly for a robotic tool changer, the tool-side assembly configured to couple to a master-side assembly of the robotic tool changer and to one or more tools used by a robot and comprising:
a locking mechanism configured to move between a locked position and an unlocked position to respectively couple and uncouple the tool-side assembly to a master-side assembly of the robotic tool changer;
a force/torque sensor comprising:
one or more sensing structures configured to elastically deform responsive to an applied force; and
one or more transducers affixed to the one or more sensing structures, wherein each of the one or more transducers is configured to send electrical signals representing a magnitude and a direction of the applied force to a measurement circuit.
